(19) United States
(12) Patent Application Publication
(10) Pub. No.: US 2026/0253507 A1
(43) Pub. Date: Aug. 27, 2026

(54) GenAI Driven Personalized Education Platform

(71) Applicant: Gen Digital Inc., Tempe, AZ (US)

(72) Inventors: Lei Gu, Bedford, MA (US); Iskander Sanchez Rola, Mountain View, CA (US)

(73) Assignee: Gen Digital Inc., Tempe, AZ (US)

(21) Appl. No.: 19/064,375

(22) Filed: Feb. 26, 2025

(51) Int. Cl. G09B 7/00; G06F 11/34; G06F 21/60; G06F 21/62

(52) U.S. Cl. CPC G09B 7/00; G06F 11/3438; G06F 21/602; G06F 21/6245

(57) ABSTRACT

A generative artificial intelligence (GenAI) driven education platform provides personalized learning experiences by leveraging large language models (LLMs) and secure data storage. The platform refines training objectives, generates context-aware scenarios, and adjusts difficulty based on user performance. User data—such as past performance, roles, and preferences—remains on-premises for privacy, supporting dynamic content adaptation without exposing sensitive information to external servers. Contextual materials, including news articles or internal documents, enhance scenario realism. Real-time feedback pinpoints knowledge gaps, while iterative updates to test cases continually evolve training modules. Applications include phishing simulations, compliance training, professional exam preparation, and more. Interactive components, such as multimedia quizzes and immersive simulations, are rendered through a customizable interface. This hyper-personalized approach boosts engagement, retention, and relevance by incorporating granular user data and ongoing performance metrics. Ultimately, organizations gain a robust, adaptive framework to deliver secure, high-impact learning across academic, corporate, and professional environments.

### FIELD OF THE DISCLOSURE

The present disclosure relates generally to computing. More particularly, the present disclosure relates to systems and methods for a generative artificial intelligence (GenAI) driven education platform.

### BACKGROUND OF THE DISCLOSURE

Computer-based education and training platforms have transformed traditional learning models by enabling digital delivery of instructional content, interactive activities, and assessments in both academic and corporate environments. Early iterations primarily focused on providing standardized coursework and basic testing functionalities, with minimal interactivity and limited capacity to adapt to individual user needs. Over time, these platforms have evolved into robust, web-based solutions that can support multimedia content, discussion forums, group collaboration, and performance tracking. This shift toward comprehensive online systems has been driven by the growing demand for cost-effective, scalable, and flexible learning tools that accommodate diverse locations, schedules, and learner profiles. Despite these advancements, however, many existing solutions still face challenges related to personalization, analytics, and adaptive learning—factors that are increasingly recognized as critical for enhancing learner engagement and outcomes.

### BRIEF SUMMARY OF THE DISCLOSURE

The present disclosure relates to systems and methods for a generative artificial intelligence (GenAI) driven education platform configured to deliver hyper-personalized learning experiences. In various embodiments, the platform leverages one or more large language models (LLMs) to refine training objectives, adapt scenario content in real time, and maintain sensitive user information within secure data stores. Users can interact with custom-generated quizzes, simulations, and other educational modules that incorporate data gleaned from past performance, recognized vulnerabilities, and stakeholder-defined learning goals. By harnessing generative AI, the platform dynamically produces multimedia assets—such as text-based exercises, interactive video segments, and immersive simulations—tailored to a learner's context, proficiency level, and professional or academic role.

In addition, the platform continuously updates its content based on real-time performance metrics, enabling it to escalate difficulty for advanced learners or provide additional foundational materials for those requiring remediation. Feedback loops further refine the scenarios, giving stakeholders and instructors data-driven insights into learner progress, knowledge gaps, and engagement trends. This robust adaptation mechanism allows organizations, educators, and training professionals to deploy context-aware, targeted curricula across diverse use cases, including K-12 education, higher education, corporate training, compliance instruction, and professional licensure exam preparation. By maintaining all personal or confidential information within on-premises or restricted cloud environments, the disclosed platform preserves data security and user privacy. Consequently, these systems and methods offer an innovative approach to delivering tailored, effective, and secure AI-driven educational experiences.

### BRIEF DESCRIPTION OF THE DRAWINGS

The present disclosure is detailed through various drawings, where like components or steps are indicated by identical reference numbers for clarity and consistency.

FIG. 1 illustrates a diagram of a system incorporating a GenAI education platform designed to deliver highly personalized, interactive educational content.

FIG. 2 illustrates a block diagram of a computing system, which may be used to implement various components in the system of FIG. 1 such as for the GenAI education platform and the user devices.

FIG. 3 illustrates a flowchart of a GenAI education process implemented via the GenAI education platform in the system of FIG. 1.

FIG. 4 illustrates a flowchart of a process for delivering personalized educational or training content using a generative artificial intelligence (GenAI) education platform.

### DETAILED DESCRIPTION OF THE DISCLOSURE

Historically, while computer-based education and training platforms have significantly improved convenience and accessibility, they have often lacked robust personalization features and have done little to leverage individual learners'histories. Early systems were primarily designed for standardized content delivery and basic testing, offering few insights into how a learner's prior knowledge or pacing preferences might influence outcomes. Without meaningful adaptability, these platforms present a uniform experience that fails to accommodate the diverse skill levels, learning styles, and performance trajectories of different users, thereby diminishing both engagement and effectiveness. Moreover, the absence of detailed analytics and real-time data tracking makes it difficult to tailor instruction, identify at-risk learners early, or refine course materials for optimal results. Consequently, instructors, administrators, and corporate trainers are left without a comprehensive view of user progress or the tools necessary to address individual needs—highlighting the critical demand for a more advanced and personalized education and training framework.

Current education, training, and testing frameworks also lack the ability to tailor materials to the unique preferences and prior experiences of individual users. For instance, in a typical K-12 platform, every student is subjected to identical lessons and assessments, even if their past performance or learning pace differs significantly. In corporate settings, employees often watch the same generic training videos without regard to their individual roles, experience levels, or performance goals, resulting in disengagement and wasted time. Personal education and testing solutions also overlook the importance of personalization; learners are often presented with standardized content that fails to resonate with their real-world experiences. This lack of customization severely impairs a user's ability to connect with and retain new information. In practice, people are far more likely to remember and internalize content that feels relevant to their own context, rather than material that appears to apply only to others. Such deficiencies underscore the necessity for a solution that can incorporate user history and continuously adapt to evolving needs, ultimately fostering deeper engagement and more effective learning outcomes.

### Education Platform

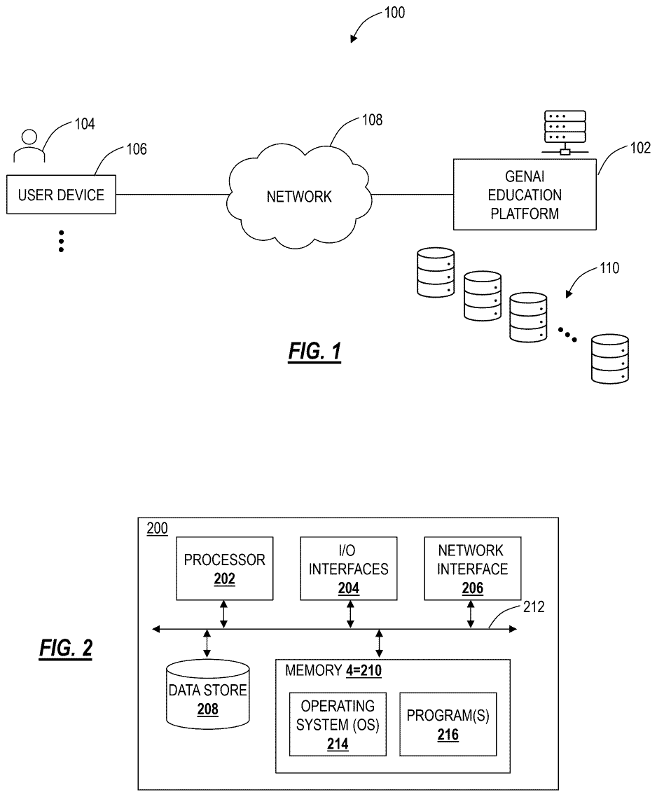

FIG. 1 illustrates a diagram of a system 100 incorporating a GenAI education platform 102 designed to deliver highly personalized, interactive educational content. The GenAI education platform 102 is configured to communicate with various users 104 on respective user devices 106 via a network 108, which may include the Internet, local area networks (LANs), wide area networks (WANs), cellular networks, or any combination thereof. In one implementation, the GenAI education platform 102 operates on a computing system—such as the computing system 200 shown in FIG. 2—that can include physical servers, clusters of machines, virtual machines (VMs) running on hypervisors, serverless computing frameworks, or a combination of these setups. By leveraging distributed computing resources, the GenAI education platform 102 can efficiently scale and handle requests from numerous users concurrently. The platform can also incorporate a data storage cluster 110, which may be composed of one or more databases, data lakes, or data warehouses, for storing and managing essential information such as user history, personalized data, training data for generative models, and other relevant datasets. The data storage cluster 110 is critical for maintaining detailed records of user interactions, progress, and preferences, enabling the GenAI education platform 102 to provide increasingly refined and adaptive learning experiences over time.

In an embodiment, the GenAI education platform 102 is offered as a cloud-based service that delivers educational content and tools to the users 104, who access the platform via their user devices 106, which can include laptops, desktops, smartphones, tablets, or other smart devices. Each user 104 has a unique, personalized account on the GenAI education platform 102, allowing the system to tailor the learning experience based on user-specific data such as past performance, course history, skill levels, and individual preferences. Moreover, the GenAI education platform 102 can integrate with external systems—like a school or corporate directory—to retrieve additional user information, including organizational roles or enrollment details. It can also maintain personally identifiable information (PII) and a record of each user's educational trajectory, ensuring that the content presented is contextually relevant and aligned with the user's objectives. This data-driven approach allows the platform to create adaptive lesson plans, deliver targeted feedback, and update content as the user progresses, thereby offering a truly customized learning journey suitable for a variety of environments, including K-12 schools, higher education institutions, and corporate training programs.

The GenAI education platform 102 is versatile and adaptable, making it suitable for a wide spectrum of educational and professional training scenarios.

General Education (K-12, Community College, and University): For traditional educational settings, such as elementary, secondary, and post-secondary institutions, the GenAI education platform 102 delivers interactive lessons, personalized quizzes, and supplemental learning resources tailored to a broad range of subjects. Using student data —like past performance, learning pace, and proficiency in specific topics—the platform can dynamically adjust the difficulty and presentation style of educational materials, ensuring each student engages with content that is appropriately challenging. Instructors gain access to real-time performance metrics, enabling them to quickly identify learning gaps and provide timely interventions. Additionally, the platform's 120 generative AI capabilities can create customized study guides, example problems, or even simulated lab experiments that match the curriculum's learning objectives, thereby enhancing both in-class and remote learning experiences.

Vocational Training for Various Trades: Whether it's automotive repair, electrical work, welding, or culinary arts, the GenAI education platform 102 can be configured to provide trade-specific tutorials, simulations, and assessments. By leveraging multimedia content—such as videos, interactive diagrams, and step-by-step guides—the platform illustrates practical techniques in a highly engaging manner. Trainees receive individualized feedback based on their performance in virtual or blended learning modules, and adaptive algorithms gauge progress to recommend additional exercises or resources. This combination of real-world skill development and AI-driven personalization streamlines the process of mastering hands-on competencies, ultimately producing more job-ready graduates.

Corporate Training for Product, Sales, Marketing, and More: In a corporate environment, the GenAI education platform 102 offers comprehensive onboarding and continued professional development programs that align with an organization's specific goals. For instance, sales representatives can receive customized modules focusing on product features and competitive analysis, while marketing teams might access dynamic case studies on campaign strategies, market research, or brand positioning. The platform's 102 personalization engine tailors content not just to role or department, but also to each employee's background knowledge, learning style, and performance history. Real-time analytics dashboards provide managers with insights into team progress and competencies, allowing them to allocate resources more effectively and address skill gaps before they affect productivity.

Certification Training for IT, Computing, and Networking: Professional certifications in IT, computing, and networking often require extensive study, practice exams, and continuous skill updates. The GenAI education platform 102 can automate much of this process by serving dynamic course material, drills, and mock tests that adapt in difficulty based on the user's demonstrated strengths and weaknesses. Learners receive immediate feedback on incorrect answers with detailed explanations and links to relevant study resources. Over time, the platform 120 refines its understanding of each learner's capabilities, providing ever more targeted practice questions and concise study summaries that optimize exam readiness. This tailored approach not only boosts pass rates but also helps professionals maintain up-to-date expertise in rapidly evolving fields.

Cybersecurity Training: As cybersecurity threats become increasingly complex, organizations must ensure their IT teams and employees are well-versed in the latest risks and defensive strategies. The GenAI education platform 102 facilitates this by presenting real-life attack simulations, phish-testing scenarios, and up-to-date tutorials on emerging threats. Interactive modules walk learners through incident response procedures, vulnerability assessments, and best practices for secure coding, all while customizing the difficulty and scope of lessons to match each user's proficiency. By consistently evaluating and adapting to performance data, the platform enables targeted reinforcement of critical concepts, ensuring that personnel remain prepared for newly emerging cybersecurity challenges.

Exam Preparation for Professional Licenses (Bar Exams, Medical Boards, etc.): High-stakes exams—such as bar exams for aspiring lawyers or board certifications for medical professionals—require a focused, rigorous study plan and access to relevant practice materials. The GenAI education platform 102 supports these needs by generating personalized study schedules, delivering comprehensive practice tests, and providing in-depth question-by-question feedback. Advanced analytics pinpoint areas of weakness, prompting the platform to deliver corrective instruction or supplementary case studies. For instance, a medical student could receive case-based lessons on differential diagnoses or pharmacology, while a law graduate might work through hypothetical legal scenarios and analyze past case rulings. The platform's 102 adaptive learning pathways ensure that each candidate invests their time in the areas most essential to improving their chances of success, ultimately fostering confidence and competence before the official exam date.

### Example Computing System Architecture and Cloud Deployment

FIG. 2 illustrates a block diagram of a computing system 200, which may be used to implement various components in the system 100 such as for the GenAI education platform 102 and the user devices 106. The computing system 200 can be implemented in many ways, including laptops, desktops, smartphones, tablets, physical servers, clusters of machines, virtual machines (VMs) running on hypervisors, or serverless computing frameworks. Regardless of the underlying infrastructure, the computing system 200 typically includes one or more processors 202, input/output (I/O) interfaces 204, a network interface 206, a data store 208, and memory 210.

It should be noted that FIG. 2 presents a simplified view; in practice, the computing system 200 may feature additional hardware and software. These components 202, 204, 206, 208, 210 are coupled via a local interface 212, which may include various wired or wireless buses, high-speed interconnects, or switching fabrics. The local interface 212 can also include controllers, buffers, caches, drivers, repeaters, and receivers, along with addressing and control lines to promote efficient communication and resource sharing among components.

Each processor 202 is a hardware element—such as a central processing unit (CPU), multicore processor, system-on-chip (SoC), graphical processing unit (GPU), or a processing element in a larger compute cluster—designed to execute software instructions. These processors may be general-purpose or specialized, selected based on performance, power efficiency, or workload needs. During operation, each processor 202 retrieves and executes instructions stored in memory 210, coordinates data exchanges with the data store 208, and manages overall system 200 activities. In large-scale environments, multiple processors 202 can be used in parallel computing architectures to handle elevated traffic and complex workloads efficiently.

The I/O interfaces 204 allow the computing system 200 to interact with external peripherals, enabling both user input (e.g., via keyboards, touchscreens, or sensors) and system output (e.g., to displays or printers). Depending on the application, these I/O interfaces 204 can also support specialized devices for maintenance, debugging, or other administrative functions. Meanwhile, the network interface 206 handles connectivity to external networks, which may include the Internet, private corporate networks, or cloud environments. This network interface can be based on Ethernet, Wireless LAN, 5G, or a virtualized cloud interface. By relying on secure transport protocols and encryption, data transmitted via the network interface 206 can remain protected, enabling the computing system 200 to participate in distributed or cloud-based deployments.

The data store 208 provides storage for both persistent and temporary data. This storage may utilize volatile memory (e.g., RAM) for transient, high-speed operations or nonvolatile media (e.g., solid-state drives, hard disk drives, optical media) for durable, long-term retention. In some deployments, the data store 208 may be integrated with network-attached storage (NAS), storage area networks (SAN), or cloud-based storage solutions. These configurations can scale from modest local setups to enterprise-level installations, potentially offering features such as global deduplication, compression, encryption at rest, and multi-site replication. The data store 208 may hold operational logs, configuration details, policy rules, program binaries, and cached computation results.

The memory 210 is the primary working memory for the processors 202, often composed of volatile elements like DRAM (e.g., DDR, SDRAM) for speed, though it may also include nonvolatile components such as Flash memory or NVRAM. Memory 210 can be distributed across nodes or servers, supporting large-scale in-memory processing demanded by modern cloud services. Typically, the memory 210 stores the operating system (O/S) 214 and one or more programs 216. The O/S 214 handles core system tasks such as process scheduling, memory allocation, file management, and networking.

For SaaS or cloud components in the system 100, the computing system 200 can be deployed as a private cloud in a single organization's datacenter, a public cloud hosted by a third-party provider, or a hybrid cloud combining elements of both for specific security, performance, or compliance considerations. Cloud computing abstracts physical hardware—servers, storage devices, network components—into on-demand, scalable resources. This enables organizations to provision computing power, storage, and network bandwidth with minimal upfront expenses, adapting to fluctuating workload demands.

According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing the hosting of applications allows providers to uniformly release new features, apply security patches, and manage licensing. These cloud-based models, often referred to as “Software as a Service” (SaaS), allow end users to access the software through browsers or lightweight client applications, benefiting from continuous improvements and frequent updates.

Various embodiments may rely on different forms of processing circuitry—general-purpose microprocessors, CPUs, network processors, GPUs, field programmable gate arrays (FPGAs), programmable logic devices (PLDs), or similar. This circuitry may be controlled by software, firmware, or a combination thereof, possibly in combination with non-processor circuits, to accomplish the functionalities outlined here. Alternatively, specific tasks may be implemented by state machines or one or more ASICs (application-specific integrated circuits), each addressing certain functions through dedicated logic. In some cases, a hybrid approach that merges these strategies may be adopted. Moreover, implementations can include a non-transitory computer-readable storage medium that holds computer-readable instructions. When executed by a device containing suitable processing circuitry, these instructions drive the system to perform the disclosed methods or algorithms. Examples of non-transitory storage media include hard disks, optical disks, magnetic devices, read-only memory (ROM), programmable ROM (PROM), erasable PROM (EPROM), electrically erasable PROM (EEPROM), flash memory, or other forms of persistent/semi-persistent storage. Once stored, the executable instructions enable the system to fulfill the methods detailed in this disclosure.

### GenAI Education Platform Process

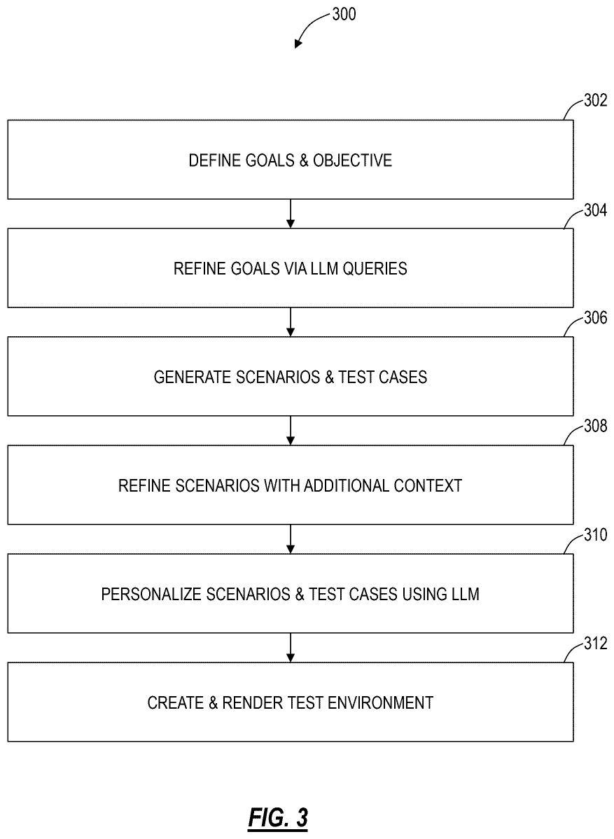

FIG. 3 illustrates a flowchart of a GenAI education process 300 implemented via the GenAI education platform 102. The process 300 outlines how an organization (e.g., a company, government agency, or school) can design and deliver personalized training and testing exercises using a large language model (LLM) and supporting tools. In various embodiments, the process 300 can be implemented in various ways, including: as a method including steps, via one or more computing systems having one or more processors configured to execute the steps, and through a non-transitory computer-readable medium that stores instructions which, when executed, cause one or more processors to perform the steps.

The process 300 begins by clearly stating the aims of the training or testing exercises (step 302). These goals could be set by companies (e.g., to train employees on new regulations or sales techniques), government agencies (e.g., cybersecurity awareness campaigns), or educational institutions (e.g., testing student understanding of curriculum topics). This can include collecting input from relevant stakeholders—such as human resources (HR) managers, security teams, or academic faculty—to ensure that these objectives align with organizational or curricular needs. This can also include identifying performance metrics to determine how success will be measured (e.g., percentage of employees who pass a security quiz, reduction in phishing click-through rates, improved exam scores, etc.).

Next, the process 300 includes refining goals via LLM queries (step 304), namely use an LLM to further refine or validate these goals. For instance, the LLM can provide additional insights or suggest common pitfalls to address, based on its training data. The LLM can offer suggestions for training topics and highlight trends that might not have been considered. For example, a government agency can query, “What recent types of scams are affecting local municipalities?” to guide cybersecurity training goals. The LLM's suggestions are integrated with stakeholder feedback to finalize a clear set of achievable, measurable objectives.

Next, the process 300 includes generating scenarios and test cases (step 306). Based on the defined goals, the process 300 includes outlining potential scenarios or test cases that reflect real-world situations. For example, if the goal is to train employees on “pig butch” scams (a type of long-term scam and investment fraud in which the victim is gradually lured into making increasing contributions), create stories or scenarios where a scammer attempts to gain trust before exploiting victims financially. This step can include collaboration with subject matter experts to consult internal experts or specialized teams (e.g., cybersecurity, compliance officers, or teachers) to ensure scenarios accurately capture relevant tasks, threats, or skills needed. This step can also leverage the LLM to produce initial drafts or lists of scenarios. For instance, the model can propose various angles on the “pig butch” scam, each tailored to different user profiles or risk levels.

Next, the process 300 includes refining scenarios with additional context (step 308). This enhances the realism and accuracy of the scenarios by feeding the LLM relevant blogs, internal documents, public studies, or recent news articles. For example, you could import the latest blog posts or case studies about “pig butch” scams to guide scenario details. The step can include an iterative review to prompt the LLM to generate multiple versions of scenarios or test cases. Human reviewers (subject matter experts, instructional designers) can then refine these outputs for completeness, correctness, and relevance. A final list of scenarios and test case is determined. At this stage, each scenario includes well-defined objectives, success criteria, and steps for testing or assessment.

The process 300 includes personalizing scenarios & test cases using the LLM (step 310). This step includes gathering personal information about each individual user in a manner compliant with data protection regulations. For instance, this can include job role, past performance, learning preferences, past history, or recognized areas of weakness. All sensitive or personally identifiable information (PII) remains on local servers. This ensures no data is sent to external (cloud-based) providers for processing, thus maintaining user privacy. The LLM then weaves this personal or contextual data into the previously finalized scenarios. For example, an employee who has previously failed phishing simulations might receive test cases that specifically address “pig butch” scam variations targeting that vulnerability. The LLM can dynamically adjust the difficulty, complexity, or style of each scenario based on the user's profile. A new hire may see straightforward challenges, while a senior staff member encounters more complex or subtle situations.

It should be noted that the term “personalization,” as used herein, is not strictly limited to tailoring content for a single individual. In various embodiments, personalization can encompass adapting educational or training materials for one or more groups of individuals, entire organizations, or subsets of users that share particular attributes or commonalities. For instance, a company may choose to customize content for all employees in a specific department, generating training scenarios that reflect shared responsibilities, compliance requirements, or workflows. Likewise, an educational institution might design lesson modules differently for various cohorts of students based on grade level, language proficiency, or prior course history.

In some implementations, personalization may draw upon aggregated data to identify overlapping characteristics among users—such as product usage habits, browsing patterns, geographic location, professional occupation, or organizational membership—and tailor the generated content accordingly. By using these shared features, the system can deliver hyper-relevant learning experiences at scale, ensuring that users not only receive materials suited to their personal or group context but also benefit from continuously updated, AI-driven insights. This versatile approach allows the platform to address a wide range of real-world scenarios, from individual-level instruction to departmental training and organization-wide initiatives, enhancing engagement, retention, and overall learning outcomes across diverse environments.

Finally, the process 300 includes creating and rendering the test environment (step 312). This can include generating interactive simulations, quizzes, videos, audio recordings, text-based scenarios, or even augmented/extended reality modules. These various media formats keep users engaged and cater to different learning preferences. The GenAI education platform 102 can host these personalized materials in the training environment—be it a Learning Management System (LMS), a custom app, or a corporate intranet. As users 104 complete their personalized training, the platform 102 collects performance data (e.g., quiz scores, time spent on modules, user feedback). This information feeds back to the LLM, which can further adjust future scenarios or recommend additional resources.

Advantageously, the process 300 facilitates the creation of highly personalized training scenarios that closely mirror the real-life situations and challenges experienced by each individual user 104, thereby significantly improving engagement and knowledge retention. In an embodiment, his process 300 can include the local hosting of the LLM, with strict safeguards in place to prevent the loss or leakage of sensitive user data; in particular, all personally identifiable information (PII) remains on-premises or within other tightly controlled environments. This setup not only fulfills stringent compliance requirements but also preserves user trust by ensuring confidentiality. Because new scam types and training topics continually emerge, the process 300 allows organizations to swiftly refine and redeploy updated scenarios without having to overhaul the entire training infrastructure. By incorporating feedback loops—where user performance data and overall system analytics inform iterative adjustments to training materials—organizations can readily identify areas of weakness, address evolving threats, and maintain ongoing improvements to their programs. Consequently, process 300 enables the delivery of adaptive, secure, and contextually relevant training and testing exercises that meet the diverse and ever-changing needs of the users 104, all while safeguarding private data throughout the lifecycle of each training module.

### Acquisition and Content Creation

The data storage cluster 110 can house an extensive range of data, such as personal information about the users 104—including personally identifiable information (PII), their past usage logs, performance history, and any other relevant behavioral metrics. In addition, this cluster stores content for training modules, supporting media like videos and images, and the LLM itself, all of which are essential for generating and delivering personalized educational experiences. Given the potentially sensitive nature of these datasets, robust security measures are implemented to preserve confidentiality for both user records and any proprietary training materials. This safeguarding of data is critical in achieving the ultimate goal of merging generative AI with rich, user-specific context to create learning experiences that are significantly more tailored and engaging than the uniform, “one-size-fits-all” approach typically seen in conventional training programs.

By drawing on user data—ranging from financial profiles and web-browsing habits to general usage patterns—the platform 102 is able to produce educational media that cater to each learner's unique needs. These media could include dynamically generated videos, quizzes, and interactive scenarios that zero in on the specific issues, knowledge gaps, and behavioral tendencies of an individual user. For instance, an employee who exhibits risky online behavior might be shown simulation-based modules highlighting potential cybersecurity threats, whereas another user more interested in financial literacy could receive targeted lessons on budgeting or investment strategies. This level of customization ensures that the content feels directly relevant to each user's personal context, significantly enhancing engagement and retention.

To obtain such detailed user data, the GenAI education platform 102 can employ various collection methods. These include monitoring user activity within the platform (e.g., frequency of logins, module completion rates), gathering PII from human resources departments or academic institutions, tapping into financial data through authorized public and private databases, and leveraging security software or local agents that track browsing history. Each source contributes valuable insights into a user's habits, preferences, and vulnerabilities, which are then stored in the data storage cluster 110. This aggregated information becomes the backbone for the platform's generative AI to craft finely tuned learning experiences.

In parallel, schools or organizations supply much of the core content—such as subject matter outlines, lectures, or policies—required for constructing test environments. This content might include textbooks, training manuals, procedural guidelines, video tutorials, or other educational resources. Combined with the user data in the cluster 110, the platform 102 can adapt these materials into scenario-based exercises that mirror real-world challenges.

The primary objective of the process 300 and the platform 102 is to cultivate a “one-on-one” relationship with every user 104, be it a student, customer, or employee. Through AI-driven personalization, the platform 102 customizes not only the text and voice of the educational materials but also the visual style, tone, and depth of coverage. For example, a novice learner might benefit from simplified analogies and explanatory videos, while an experienced user may prefer concise bullet points and advanced case studies. This increased degree of personalization promotes stronger motivation and engagement because the user perceives the material as immediately relevant and beneficial.

Advances in generative AI are making it increasingly feasible to create on-the-fly, high-quality video content. Although these technologies are evolving, existing breakthroughs in text, audio, and video generation indicate that fully dynamic, real-time educational media could become mainstream in the near future. These can be seamlessly incorporated into the GenAI education platform 102, empowering organizations to deliver unique, on-demand lessons and simulations that respond to each learner's evolving needs and capabilities.

The platform 102 can also integrate gamification elements, including quizzes, reward points, digital badges, and other interactive features to further incentivize user participation. Such mechanisms are particularly effective for maintaining learner engagement over extended training programs or long-term educational commitments. A key aspect of this approach is the intelligent fusion of a wide range of behavioral, financial, and security data with generative AI techniques. Unlike conventional personalization methods that might rely on static user profiles or single-dimensional analytics, this synergy allows the platform 102 to dynamically construct and adapt content based on complex user patterns, real-time performance metrics, and evolving threat landscapes.

For example, by analyzing a user's financial behavior—such as online transaction habits—the system can identify specific points of vulnerability and generate targeted cybersecurity simulations. In parallel, it might tap into security logs to highlight instances where the user nearly fell victim to a phishing scheme, then create scenario-based quizzes or immersive simulations that mirror those threats. Combining all these data sources with state-of-the-art generative AI further enables the creation of on-demand media (e.g., videos, interactive simulations) personalized to each individual's role, expertise level, and demonstrated learning gaps. This data-driven generative process is precisely what renders the platform's 102 capabilities unique and high-impact, as it continually refines and reshapes educational content in direct response to real-time signals—far exceeding the one-size-fits-all methods seen in standard e-learning or corporate training systems.

In essence, the collective goal is to leverage generative AI to deliver a deeply customized, interactive educational ecosystem that caters to a wide array of use cases, ranging from financial wellness or cybersecurity awareness in consumer-facing applications to compliance or professional development in corporate environments. By continually refining data inputs, applying new AI-driven content generation tools, and focusing on user engagement through gamification and personalization, the platform 102 stands poised to redefine how education and training programs are envisioned, deployed, and experienced. This ongoing integration of advanced data analytics with generative AI guarantees a self-improving feedback loop, empowering the platform to evolve alongside user behaviors, emerging threats, and organizational objectives—ultimately delivering ever more individualized and effective learning experiences.

### Applications

In an embodiment, the platform 102 could revolutionize corporate IT and data security training—such as phishing awareness or scam detection—by simulating highly realistic and personalized phishing attempts tailored to an employee's actual work environment and past behaviors. Rather than relying on generic, easily recognizable phishing templates, the platform 102 leverages context-specific data (e.g., previous collaborations, corporate naming conventions, common email signatures, and ongoing projects) to craft messages that resonate with the employee's daily tasks. For instance, an employee in the finance department might receive a fraudulent email referencing a recent invoice number, a known vendor, or even an internal project code from their last department meeting. By weaving in these realistic details, the training scenarios become significantly more challenging and instructive—offering employees firsthand exposure to what a genuine, highly targeted phishing attempt might look like.

Moreover, the platform 102 can analyze an individual's communication style—including typical greeting formats, sign-off habits, and writing tone—to generate phishing content that closely mimics legitimate internal correspondence. For example, a user who frequently interacts with a specific coworker, “Alex,” might receive a spoofed email appearing to come from Alex, referencing a recent Slack conversation or a project milestone. Employees are then prompted to detect the subtle cues indicating fraud, such as inconsistencies in language, mismatched domain names, or suspicious attachment requests. Because the system employs local generative AI with access to each user's historical context, it can automatically adapt scenarios over time, gradually increasing complexity to match the employee's improved detection skills. By providing a “hyper-personalized” approach to security training, organizations can better prepare employees for real-world threats. Users who successfully spot and flag deceptive details in these exercises receive immediate feedback and guidance on how to handle similar incidents, thereby reinforcing best practices. Conversely, if an employee falls for a simulated scam, the platform can automatically offer supplemental learning materials or additional quizzes to address specific vulnerabilities. Through this iterative, user-centric methodology, security awareness is continuously refined, surpassing what is possible with generic one-size-fits-all exercises. Overall, this targeted and context-driven model strengthens organizational security preparedness by ensuring employees have experienced a range of plausible phishing threats before ever facing a genuine attack.

In other embodiments, the platform 102 could transform not only corporate IT and data security training—such as phishing awareness or scam detection—but also a broad spectrum of additional training scenarios that demand dynamic, context-aware instruction. For example, it can simulate social engineering attempts (e.g., someone impersonating an executive requesting sensitive information), malware infiltration tactics (e.g., suspicious links or attachments appearing in a user's workflow), and ransomware exposures (e.g., realistic pop-up warnings masquerading as urgent system updates). By drawing on an employee's actual work environment—such as recent project files, departmental contacts, or communication patterns—the platform 102 generates highly customized training exercises that closely mirror real-world attack vectors. This hyper-personalization replaces generic cues with compelling details tied to genuine responsibilities, communication styles, and workplace norms.

Beyond cybersecurity, the same approach can be extended to compliance training and regulatory instruction. A financial institution, for example, might leverage user-specific data—such as transaction histories and client interactions—to create role-based AML (Anti-Money Laundering) or KYC (Know Your Customer) modules, prompting employees to identify red flags that align with real cases they might encounter. In healthcare contexts, the platform can incorporate HIPAA compliance simulations, evaluating patient data handling in realistic clinical settings. Similarly, marketing or sales teams can receive interactive product training guided by actual sales figures, customer demographics, and campaign data, ensuring that the learning environment matches their real work challenges. By integrating local generative AI, the platform 102 can adapt these modules over time as new threats, regulations, or company policies emerge—adjusting difficulty, content depth, and presentation style based on each user's performance and feedback. For instance, an employee who has mastered basic phishing detection might progress to advanced social engineering scenarios involving phone-based impersonations or multi-step scam attempts, while those who struggle with compliance quizzes can be given additional, more fundamental exercises.

Through immediate feedback loops, users gain clear insights into their mistakes, fostering a cycle of continuous improvement. If a user falls victim to a simulated ransomware prompt, the system can immediately highlight the missed indicators and recommend a brief, tailored tutorial on verifying file authenticity or identifying spoofed web domains. This iterative process is designed to heighten retention, align with organizational policies, and bolster overall preparedness for genuine real-world challenges. By moving beyond phishing to incorporate a full array of security, compliance, and role-based training scenarios, the platform 102 delivers an adaptable, deeply personalized learning ecosystem that sets a new standard in both educational effectiveness and data-driven customization.

### Use Case Example: “Pig Butch” Scam Awareness

In this example, the term “Pig Butch” scam refers to a sophisticated form of financial fraud where scammers invest significant time in building a personal relationship—often romantic or friendly—before exploiting the victim's trust to solicit money. Below is a structured approach that demonstrates how an organization can leverage a LLM-based platform to train on recognizing and responding to this growing threat, using the steps in the process 300.

Define Goals & Objectives (step 302): The first phase involves articulating clear objectives for the training initiative. In this scenario, the primary goal is to reduce the success rate of targeted financial scams within the organization by improving employees'ability to identify warning signs and respond effectively. Stakeholders—such as HR, security teams, or compliance officers—identify the specific outcomes they wish to achieve, including measuring how many employees correctly spot suspicious interactions and how quickly they report potential threats.

Refine Goals via LLM Queries (step 304): Once the basic objectives are set, the organization taps into a LLM to refine the scope of the training. A query might ask, “Provide a structured approach to training employees on common scam tactics, including pig butch scams, that financial institutions are seeing today.” The LLM responds with suggestions emphasizing social engineering tactics, emotional manipulation, and typical red flags found in pig butch scams. This feedback ensures the training is comprehensive and up-to-date with the latest scam variants. Further conversations with the LLM can also uncover blind spots or emerging scam trends to incorporate into the training curriculum.

Generate Scenarios & Test Cases (step 306): With refined goals, the next step is to brainstorm possible scam narratives and test scenarios. For a pig butch scam, an illustrative storyline might involve a friendly new colleague or online acquaintance gradually building trust over several weeks—exchanging casual chats and personal anecdotes—before eventually asking for urgent financial help due to a “family emergency” or “medical crisis.” By sketching out these narratives in detail, the organization can create multiple levels of complexity for different employee groups. Junior staff, for example, might only see basic scam attempts, while senior managers could be tested with more sophisticated narratives that involve hierarchical references or interdepartmental lingo.

Refine Scenarios with Additional Context (step 308): To make the training scenarios authentically reflective of real-world events, the LLM is supplied with recent local news stories or internal incident reports related to pig butch scams. This step ensures that the language, timeframes, and tactics in each scenario closely match what employees might encounter in an actual attack. If, for instance, local newspapers have covered a rise in cryptocurrency-based scams, the training might incorporate references to digital wallets or crypto investment schemes. By weaving in current, location-specific details, the organization can maintain training relevance and heighten employee engagement.

Personalize Scenarios & Test Cases Using a LLM (step 310): Personalization is key to making the training impactful. At this stage, the organization uploads relevant user data—such as job role, past security training records, or known vulnerabilities—into the LLM (ensuring that all sensitive data remains on-premises and in compliance with privacy standards). The system then modifies the existing pig butch scam scripts so they align with each employee's actual communication channels and personal interests. An employee who frequently discusses sports on social media might encounter a scam narrative revolving around a shared enthusiasm for a particular team. Another user who is “click-happy” in email communications might be tested with realistic links and attachments. By adapting each scenario to the user's genuine behaviors and preferences, the training heightens realism and challenges employees to remain vigilant in everyday contexts.

Create & Render the Test Environment (step 312): Finally, the platform 102 renders these personalized scenarios in a test environment that can include text-based simulations, video content, or even interactive role-play elements. For instance, an employee might receive an email from a supposed new colleague referencing shared interests or departmental projects, eventually leading to a request for funds. The platform 102 provides real-time feedback: if the user opens malicious links or shares sensitive information, the system highlights missed red flags and outlines how to respond properly. By contrast, users who correctly identify suspicious details can receive positive reinforcement and advanced training modules. Over time, continuous performance tracking and iterative scenario updates ensure that employees develop a deeper, more instinctual awareness of pig butch scams and related fraud schemes.

By following these steps, organizations stand to significantly enhance their employees'ability to recognize and respond to emerging financial scams. The LLM-driven process allows for ongoing updates based on new threats or changing workplace dynamics, thereby creating a living training ecosystem that evolves in step with the real world. Moreover, the hyper-personalized approach ensures relevance for each individual, increasing overall engagement and retention rates. Ultimately, this methodology fosters a proactive security culture in which employees are well-equipped to spot sophisticated scam attempts—like pig butch scams—before falling victim to them.

### Use Case Example: Recognize “Grandson in Foreign Jail” Scam

Below is a structured approach for training users to recognize and respond to a common social engineering scam scenario, often referred to as the “Grandson in Foreign Jail” or “Emergency” scam. The goal is to help individuals—particularly those who might be more vulnerable, such as grandparents—understand how realistic and manipulative these calls can be, and to empower them to respond appropriately in a real situation.

Define Goals & Objectives (step 302): The primary objective is to train the user to identify and resist the “Grandson in Foreign Jail” scam. In this scheme, scammers often pretend to be a grandchild who is in urgent need of bail money or other forms of financial help. Establish clear goals, such as reducing the success rate of these scams and improving recognition of suspicious phone calls. Stakeholders (e.g., family members, community organizations, or security training teams) determine the success criteria, which might include the user demonstrating the ability to notice red flags or knowing the correct verification steps before sending money.

Refine Goals via LLM Queries (step 304): Leverage a LLM to refine the training approach. For instance, pose a query to the LLM such as: “Provide best practices for designing a training module that teaches elderly users to identify and resist the ‘Grandson in Foreign Jail’ scam, using voice deepfakes and real-world examples.” The LLM might suggest focusing on emotional manipulation cues (e.g., urgency, secrecy) and highlight best practices for verifying the caller's identity. This step ensures that the training is aligned with current scam tactics and includes relevant psychological triggers that scammers frequently exploit.

Generate Scenarios & Test Cases (step 306): Next, draft possible scam narratives based on actual “Grandson in Foreign Jail” incidents. A typical scenario might feature:
(1) A frantic call claiming that the “grandson” is incarcerated in another country (e.g., Italy) and needs bail money immediately.
(2) Emotional pressure, such as threats of dire consequences if immediate action is not taken.
(3) Instructions to keep the matter secret “so the situation doesn't get worse.”

By outlining these story elements, you create multiple test cases for different user profiles—ranging from subtle requests for smaller sums to large, urgent pleas that demand thousands of dollars.

Refine Scenarios with Additional Context (step 308): To make the training scenarios highly realistic, provide the LLM with recent news articles, scam reports, or internal security bulletins focusing on voice-based impersonation and fraudulent phone calls. This additional context allows the LLM to refine language, adapt timing cues, and include real-world details—such as referencing specific bail amounts or local law enforcement agencies. For instance, if a recent local headline involved scammers using a particular foreign jail location, the training scenario can incorporate that detail to mirror actual incidents.

Personalize Scenarios & Test Cases Using a LLM (step 310): Personalization is crucial for creating authentic experiences that resonate with the user. Here, you can:
(1) Collect Relevant User Data: Gather information about the user's family structure, including the names of grandchildren, favorite sports teams, or any known travel habits.
(2) Leverage Audio Samples: If you have an approved audio sample of the user's actual grandchild, feed it to a AI model that can generate a deepfake voice.
(3) Build Context-Specific Scripts: The LLM adapts the scam call script using details like the grandson's name, the user's phone number, and the user's interests or routines.

For example, a call might begin with a deepfake voice saying, “Hi Grandma, it's [Grandson's Name]. I'm in jail in Italy after a misunderstanding during a soccer match. I need you to send bail money right away!” By addressing the user personally and invoking family references, the scenario becomes far more convincing.

Create & Render the Test Environment (step 312): Finally, deploy the simulated scam call in a controlled setting. The platform places a phone call to the user—using the deepfake voice and referencing personal details—and urges them to send money. Even if the user is aware this is part of a training exercise, the personalization and realistic voice rendering can make it challenging for them to dismiss. Immediately after the call, the system provides real-time feedback and guidance:
(1) If the user hesitates and asks verification questions (e.g., “What was my nickname for you when you were 5 years old?”), they receive positive reinforcement for demonstrating cautious behavior.
(2) If the user appears ready to comply with the scammer's request, they are shown a post-call debrief explaining which red flags should have been noticeable—such as unusual phone numbers, improbable emergency situations, or contradictory background details.

By experiencing a highly realistic scenario, the user is more likely to remember and apply these defensive measures if they ever receive a similar call in the future. This reinforces the training in a way generic tips and warnings cannot match.

Through the application of LLM technologies, voice deepfakes, and real-time personalization, this training process provides an immersive, impactful learning experience. Users not only learn to recognize the emotional manipulation strategies behind a “Grandson in Foreign Jail” scam but also develop practical, muscle-memory responses—such as verifying the caller's identity or contacting a trusted family member. This robust, experience-based approach significantly boosts their resilience against sophisticated scams, ensuring they are better protected in real-life scenarios.

### Detailed Use Case Example: “Ex-Colleague Seeking Confidential Company Information”

Below is a structured approach that demonstrates how an organization can train employees to identify and avoid disclosing sensitive company details when approached by someone impersonating a trusted ex-colleague.

Define Goals & Objectives (step 302): The primary objective is to train internal employees on how to recognize and handle situations where they are prompted—perhaps under false pretenses—to share confidential or proprietary information. By simulating a scenario in which a scammer impersonates a familiar ex-colleague, the training aims to increase vigilance and reduce the incidence of inadvertent data leaks.

Refine Goals via LLM Queries (step 304): Utilize the LLM to refine the training approach. For instance, you might query: “Suggest strategies for creating a realistic scenario in which an ex-colleague attempts to obtain confidential company data from an employee.” The LLM could recommend focusing on relationship-based social engineering, highlighting the significance of personal rapport, prior collaborations, and shared successes that foster a sense of trust. It may also advise on the red flags employees should watch for—such as unusual email domains or requests for unauthorized details about upcoming projects.

Generate Scenarios & Test Cases (step 306): Next, draft possible scam narratives reflecting genuine ex-colleague interactions. A sample scenario might involve a scammer posing as an ex-colleague who was deeply involved in a major project and is now reaching out to “catch up” or check on development milestones. The conversation escalates to requests for sensitive product details, competition strategies, or proprietary release timelines. Multiple variations can be created to address different employee roles and levels of access, with some focusing on project deadlines and others highlighting competitive risks.

Refine Scenarios with Additional Context (step 308): To make the training highly realistic, enrich the LLM's knowledge base with previous correspondence between the actual ex-colleague and the target employee, as well as relevant internal documents or communication logs. If the ex-colleague regularly used a particular phrasing, nickname, or sign-off, ensure these traits appear in the fabricated messages. If there is a notable past project that generated substantial revenue, the scenario can reference those milestones to heighten believability.

Personalize Scenarios & Test Cases Using a LLM (step 310): Personalization is key to this approach. By analyzing the employee's data—such as recent project involvements, stored emails, or known relationships—the LLM can accurately mimic the ex-colleague's writing style and communication preferences. Specific details could include:
(1) Identifying a real ex-colleague the employee was particularly close to.
(2) Referencing actual product launch details from the last time they collaborated.
(3) Using a plausible personal email address closely resembling the ex-colleague's real handle (e.g., firstname_lastname_123@yahoo.com).

These touches make the phishing email appear authentic, lowering the employee's guard by evoking genuine past interactions.

Create & Render the Test Environment (step 312): Finally, deploy the simulated scam in a controlled training environment. The employee receives an email from what seems to be their ex-colleague, referencing a high-value future product launch and requesting updates or confidential details. Because the messaging carefully reflects prior communications—complete with matching tone, project references, and personal rapport—the employee may feel comfortable divulging information. Immediately following the exchange, real-time feedback is provided:
(1) Employees who disclose private data receive a debrief outlining the red flags they missed (e.g., the suspicious domain name, the unusual nature of asking for confidential updates via a personal email).
(2) Those who respond cautiously—e.g., by verifying the sender's identity via a separate channel or refusing to share sensitive details over personal email—receive reinforcement for best practices.

By confronting employees with a highly realistic and personalized social engineering scenario, the training helps them develop a heightened sense of awareness regarding requests for proprietary company information. They learn to scrutinize communications—even from seemingly familiar sources—before divulging sensitive data. Over time, such iterative, scenario-based lessons reduce the risk of data leaks, fortify overall security culture, and illustrate the critical role that trust and personal familiarity can play in successful social engineering attacks.

### Process For

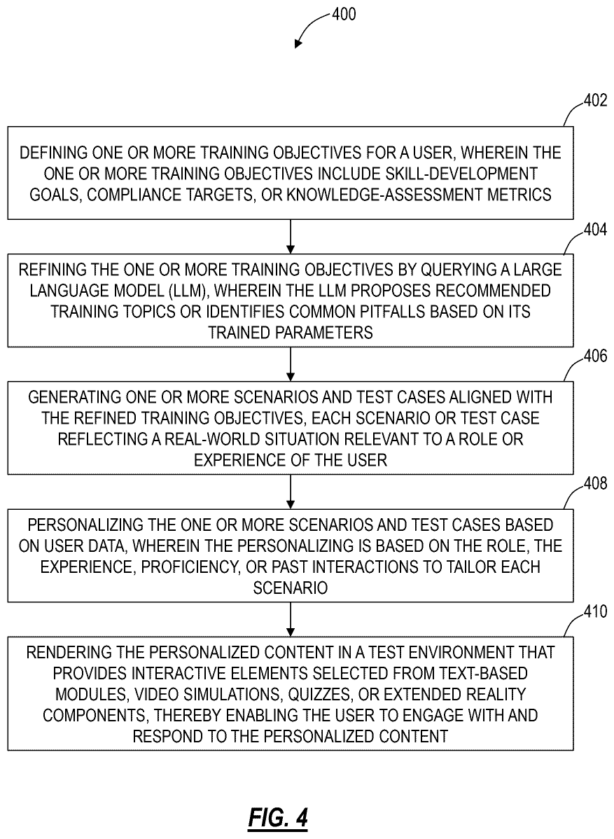

FIG. 4 illustrates a flowchart of a process 400 for delivering personalized educational or training content using a generative artificial intelligence (GenAI) education platform. In various embodiments, the process 400 can be implemented in various ways, including: as a method including steps, via one or more computing systems having one or more processors configured to execute the steps, and through a non-transitory computer-readable medium that stores instructions which, when executed, cause one or more processors to perform the steps. This flexibility ensures the process 400 can be adapted to different system architectures and deployment scenarios.

The process 400 includes defining one or more training objectives for a user, wherein the one or more training objectives include skill-development goals, compliance targets, or knowledge-assessment metrics (step 402); refining the one or more training objectives by querying a large language model (LLM), wherein the LLM proposes recommended training topics or identifies common pitfalls based on its trained parameters (step 404); generating one or more scenarios and test cases aligned with the refined training objectives, each scenario or test case reflecting a real-world situation relevant to a role or experience of the user (step 406); personalizing the one or more scenarios and test cases based on user data, wherein the personalizing is based on the role, the experience, proficiency, or past interactions to tailor each scenario (step 408); and rendering the personalized content in a test environment that provides interactive elements selected from text-based modules, video simulations, quizzes, or extended reality components, thereby enabling the user to engage with and respond to the personalized content (step 410).

The process 400 can further include storing the user data, including personally identifiable information (PII) and historical performance logs, in a secure local data store that prevents unauthorized access or exfiltration of the user data. The process 400 can further, include prior to the storing, collecting user data by gathering information from at least one of: user activity logs within the GenAI education platform; external enterprise or academic directories; authorized monitoring of user browsing history; or previous training records, such that the user data is analyzed to identify risk profiles, learning preferences, or knowledge gaps. The secure local data store can be configured to encrypt and partition all stored PII, thereby ensuring that sensitive user information remains protected in compliance with data protection regulations and is not inadvertently exposed to external servers or third parties.

The process 400 can further include supplying additional contextual materials including at least one of recent news articles, internal documents, or domain-specific data to the LLM to enhance realism, relevance, or accuracy of the one or more scenarios and test cases. The process 400 can further include one of providing real-time feedback to the user as the user engages with the personalized content; and storing the feedback for future iterations of the personalizing, wherein the feedback identifies correct or incorrect decisions, highlights missed indicators, and offers recommended follow-up resources. The real-time feedback can include contextual guides, example solutions, or best-practice references displayed upon detecting user errors, prompting the user to review and correct identified deficiencies.

The process 400 can further include iteratively updating subsequent scenarios or test cases based on at least one of performance metrics for the user, behavioral data, or feedback logs, to continuously address emerging gaps or vulnerabilities. The LLM can dynamically adjust complexity or difficulty of each scenario or test case in response to real-time performance, so that a user demonstrating improved proficiency is presented with more advanced challenges, while a user requiring additional support receives more fundamental materials. The refining the one or more training objectives via the LLM further can include incorporating stakeholder feedback from at least one of human resources managers, security teams, academic faculty, or subject matter experts. The process 400 can further include leveraging role-based access controls to restrict or unlock particular scenarios or test cases for users holding specific roles, thereby ensuring alignment with organizational policies and confidentiality requirements.

The personalizing the one or more scenarios includes can include at least one context including: a phishing or social-engineering attempt reflecting a communication style of the user; a high-stakes examination environment replicating a professional certification; or a compliance scenario targeted to a regulatory jurisdiction or departmental function for the user. The rendering the personalized content can further include generating on-demand multimedia assets, including at least one of: generative AI-based video segments replicating familiar voices or likenesses; branching simulations prompting user decisions or role-play; or gamified exercises awarding digital badges or achievement points. The process 400 can further include automatically detecting a user's vulnerabilities or knowledge gaps by analyzing historical user data; and providing supplementary learning modules or corrective feedback tailored to address the user's vulnerabilities or knowledge gaps. The process 400 can further include integrating gamification elements, including timed quizzes, collaborative challenges, or leaderboard rankings, to maintain user motivation and reinforce knowledge retention.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A computer-implemented method for delivering personalized educational or training content using a generative artificial intelligence (GenAI) education platform, the method comprising steps of:
defining one or more training objectives for a user, wherein the one or more training objectives include skill-development goals, compliance targets, or knowledge-assessment metrics;
refining the one or more training objectives by querying a large language model (LLM), wherein the LLM proposes recommended training topics or identifies common pitfalls based on its trained parameters;
generating one or more scenarios and test cases aligned with the refined training objectives, each scenario or test case reflecting a real-world situation relevant to a role or experience of the user;
personalizing the one or more scenarios and test cases based on user data, wherein the personalizing is based on the role, the experience, proficiency, or past interactions to tailor each scenario; and
rendering the personalized content in a test environment that provides interactive elements selected from text-based modules, video simulations, quizzes, or extended reality components, thereby enabling the user to engage with and respond to the personalized content.

2. The method of claim 1, wherein the steps further include:
storing the user data, including personally identifiable information (PII) and historical performance logs, in a secure local data store that prevents unauthorized access or exfiltration of the user data.

3. The method of claim 2, wherein the steps further include:
prior to the storing, collecting user data by gathering information from at least one of:
user activity logs within the GenAI education platform;
external enterprise or academic directories;
authorized monitoring of user browsing history; or
previous training records, such that the user data is analyzed to identify risk profiles, learning preferences, or knowledge gaps.

4. The method of claim 2, wherein the secure local data store is configured to encrypt and partition all stored PII, thereby ensuring that sensitive user information remains protected in compliance with data protection regulations and is not inadvertently exposed to external servers or third parties.

5. The method of claim 1, wherein the steps further include:
supplying additional contextual materials comprising at least one of recent news articles, internal documents, or domain-specific data to the LLM to enhance realism, relevance, or accuracy of the one or more scenarios and test cases.

6. The method of claim 1, wherein the steps further include one of:
providing real-time feedback to the user as the user engages with the personalized content; and
storing the feedback for future iterations of the personalizing,
wherein the feedback identifies correct or incorrect decisions, highlights missed indicators, and offers recommended follow-up resources.

7. The method of claim 6, wherein the real-time feedback comprises contextual guides, example solutions, or best-practice references displayed upon detecting user errors, prompting the user to review and correct identified deficiencies.

8. The method of claim 1, wherein the steps further include:
iteratively updating subsequent scenarios or test cases based on at least one of performance metrics for the user, behavioral data, or feedback logs, to continuously address emerging gaps or vulnerabilities.

9. The method of claim 1, wherein the LLM dynamically adjusts complexity or difficulty of each scenario or test case in response to real-time performance, so that a user demonstrating improved proficiency is presented with more advanced challenges, while a user requiring additional support receives more fundamental materials.

10. The method of claim 1, wherein the refining the one or more training objectives via the LLM further comprises incorporating stakeholder feedback from at least one of human resources managers, security teams, academic faculty, or subject matter experts.

11. The method of claim 1, wherein the steps further include:
leveraging role-based access controls to restrict or unlock particular scenarios or test cases for users holding specific roles, thereby ensuring alignment with organizational policies and confidentiality requirements.

12. The method of claim 1, wherein the personalizing the one or more scenarios includes simulating at least one context including:
a phishing or social-engineering attempt reflecting a communication style of the user;
a high-stakes examination environment replicating a professional certification; or
a compliance scenario targeted to a regulatory jurisdiction or departmental function for the user.

13. The method of claim 1, wherein the rendering the personalized content further comprises generating on-demand multimedia assets, including at least one of:
generative AI-based video segments replicating familiar voices or likenesses;
branching simulations prompting user decisions or role-play; or
gamified exercises awarding digital badges or achievement points.

14. The method of claim 1, wherein the steps further include:
automatically detecting a user's vulnerabilities or knowledge gaps by analyzing historical user data; and
providing supplementary learning modules or corrective feedback tailored to address the user's vulnerabilities or knowledge gaps.

15. The method of claim 1, wherein the personalizing is for one or more groups of individuals, entire organizations, or subsets of users that share particular attributes or commonalities.

16. A generative artificial intelligence (GenAI) education platform for delivering personalized educational or training content, the GenAI education platform comprising:
one or more processors; and
memory storing instructions that, when executed, cause the one or more processors to
define one or more training objectives for a user, wherein the one or more training objectives include skill-development goals, compliance targets, or knowledge-assessment metrics;
refine the one or more training objectives by querying a large language model (LLM), wherein the LLM proposes recommended training topics or identifies common pitfalls based on its trained parameters;
generate one or more scenarios and test cases aligned with the refined training objectives, each scenario or test case reflecting a real-world situation relevant to a role or experience of the user;
personalize the one or more scenarios and test cases based on user data, wherein the personalizing is based on the role, the experience, proficiency, or past interactions to tailor each scenario; and
render the personalized content in a test environment that provides interactive elements selected from text-based modules, video simulations, quizzes, or extended reality components, thereby enabling the user to engage with and respond to the personalized content.

17. The GenAI education platform of claim 16, wherein the instructions that, when executed, cause the one or more processors to
supply additional contextual materials comprising at least one of recent news articles, internal documents, or domain-specific data to the LLM to enhance realism, relevance, or accuracy of the one or more scenarios and test cases.

18. The GenAI education platform of claim 16, wherein the instructions that, when executed, cause the one or more processors to
iteratively update subsequent scenarios or test cases based on at least one of performance metrics for the user, behavioral data, or feedback logs, to continuously address emerging gaps or vulnerabilities.

19. A non-transitory computer-readable medium for delivering personalized educational or training content using a generative artificial intelligence (GenAI) education platform, the non-transitory computer-readable medium storing instructions that, when executed, cause one or more processors in the GenAI education to perform steps of:
defining one or more training objectives for a user, wherein the one or more training objectives include skill-development goals, compliance targets, or knowledge-assessment metrics;
refining the one or more training objectives by querying a large language model (LLM), wherein the LLM proposes recommended training topics or identifies common pitfalls based on its trained parameters;
generating one or more scenarios and test cases aligned with the refined training objectives, each scenario or test case reflecting a real-world situation relevant to a role or experience of the user;
personalizing the one or more scenarios and test cases based on user data, wherein the personalizing is based on the role, the experience, proficiency, or past interactions to tailor each scenario; and
rendering the personalized content in a test environment that provides interactive elements selected from text-based modules, video simulations, quizzes, or extended reality components, thereby enabling the user to engage with and respond to the personalized content.

20. The non-transitory computer-readable medium of claim 19, wherein the steps further include
supplying additional contextual materials comprising at least one of recent news articles, internal documents, or domain-specific data to the LLM to enhance realism, relevance, or accuracy of the one or more scenarios and test cases.
